(19) United States
(12) Patent Application Publication
(10) Pub. No.: US 2008/0040094 A1
(43) Pub. Date: Feb. 14, 2008

(54) Proxy For Real Time Translation of Source Objects Between A Server And A Client

(75) Inventors: Mark R. Wolgemuth, Atlanta, GA (US); John David Alberg, Atlanta, GA (US)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: Employease, Inc., Norcross, GA (US)

(21) Appl. No.: 11/463,098

(22) Filed: Aug. 8, 2006

(51) Int. Cl. G06F 17/28

(52) U.S. Cl. 704/2

(57) ABSTRACT

The present invention relates to a proxy for providing a translated source object, the proxy comprising: (i) a first interface with a client, (ii) a second interface, (iii) a third interface, (iv) a translating engine, and (v) an output interface, wherein the translating engine performing the steps of: (a) receiving the source object in the first language from the server, (b) parsing the source object into a plurality of source tokens in the first language, (c) obtaining from the token database replacement tokens, if any, for each source token, and (d) compiling the translated source object wherein the translated source object includes all of the replacement tokens obtained from the token database and all of the parsed source tokens for which there was no corresponding replacement token in the token database.

### FIELD OF THE INVENTION

The present invention relates generally to the field of translating and display of electronic documents and, in particular, to the real-time translation of source objects from one language to another, user-selectable language by using replacement tokens.

### BACKGROUND OF THE INVENTION

With the exponential growth of the Internet, computer users rely more and more on the use of the World Wide Web (or “web”) as a major source of information. On the web, a client program called a web browser retrieves information resources, such as web pages and other computer files, from web servers using their Uniform Resource Locator (hereinafter URL) and displays them, typically using a computer monitor, or a portable electronic device such as a personal digital assistant (PDA) or and Internet accessible cellular telephone. One can then follow hyperlinks in each page to other resources on the web whose location is provided by these hyperlinks. It is also possible, for example, by filling in and submitting web forms, to post information back to a web server for it to save or process in some way. The act of following hyperlinks is often called “browsing” or “surfing” the web. Web pages are often arranged in collections of related material called “websites.”

A website is a collection of web pages, typically common to a particular domain name or sub-domain on the web on the Internet. To date, there are over 81 million websites in the world with registered domains—and this number grows daily. All publicly-accessible websites are seen as constituting a mammoth “World Wide Web” of information. The pages of a website are accessed from a common root URL called the homepage, and usually reside on the same physical server. The URLs of the pages organize them into a hierarchy, although the hyperlinks between them control how the reader perceives the overall structure and how the traffic flows between the different parts of the sites.

Some websites require a subscription to access some or all of their content. Examples of subscription sites include parts of many news sites, gaming sites, message boards, Web-based e-mail services and sites providing real-time stock market data. Web pages can change their information frequently, as a Dynamic Web Page, or maintain constant format and content, as a Static Web Page. These web pages are published in may different languages. The majority of the web pages are published in English. One particular demand of Internet users is better language translation capability, i.e. to provide the instant translation of web pages from its original, published language to a user-selectable language.

Translation of a web page from one language to another language is a very important tool for web users, and a very difficult task as well. Many companies currently offer or attempt to offer various services of translating web pages from one language to another language. For example, AltaVista® offers a web translation services, which allows a user to enter a web address, which is then translated from its original language to a language selected by the user. However, a quick inspection of the translated page indicates that the translation is based on work-phrase or segment of the original language and certain grammatical rules, The translation is completed with a technology known as machine translation. Often, such translated text is awkward and no more than a mere sequence of dissconnected words, phrases, or segments that, although technically accurate, do not present the web page in a manner in which it would have been viewed if written by a native writer.

The task of machine translation is defined very simply: the computer must be able to obtain as input a text in one language (SL, source language) and produce as output a text in another language (TL, target language), so that the meaning of the TL text is sufficiently close to that of the SL text. Machine Translation is a process that utilizes computer software to translate text from one natural language into another. This attempts to account for the grammatical structure of each language and uses rules and assumptions to transfer language (translated text). It is not a mere substitution for each word, but being able to know “all of the words” in a given sentence or phrase and how one may influence the other. Human languages consist of morphology (the way words are built up from small meaning-bearing units), syntax (sentence structure), semantics (meanings), and countless ambiguities. These parts of the human languages can only be covered by certain grammatical rule or knowledge-based special rules. With current technology and due to the many nuances that exist in any written and spoken language, using machine translation is adequate for many purposes, but not when a perfect or almost perfect translation is needed.

A costly alternative to machine translation is the actual creation of the same web page or electronic document in a plurality of target languages. This approach requires the web page publishers/designers to create the web pages in every different language desired. The translation and the creation of the web pages are typically carried out by experienced information technology (IT) professionals who understand both the source and the target languages. This requirement increases the cost of producing web pages in other languages since one must find not only an IT professional to create the web page but also one who can translate the web page from the source language to the target language. Such professionals are hard to find an are likely to require higher salaries. To reduce the cost, it is preferred to separate out the tasks that must be formed by experienced IT professional from those tasks that can be performed by translators who are not necessarily IT professionals.

If some web pages are required to be displayed in many different languages, the conventional practice requires multiple web hosting servers and multiple web page development—one in each desired language. If locale characteristics are taken into consideration, the number of web hosing servers and development of these servers can end up being multiplied many times over. Such an approach is certainly not economical.

Therefore, a heretofore unadressed need exists in the art to address the aforementioned deficiencies and inadequacies.

### SUMMARY OF THE INVENTION

The present invention, in one aspect, relates to a method for providing a translated source object by a proxy. In one embodiment, the proxy performs the steps of: (i) receiving a request from a client for a source object in a second language, the source object stored on a server in a first language, (ii) retrieving the requested source object from the server, (iii) creating the translated source object in the second language, and (iv) transmitting the translated source object to the client. The translated source object in the second language is created by performing the steps of: (a) parsing the source object into a plurality of source tokens in the first language, (b) for each source token in the first language, determining if there is a corresponding replacement token in the second language in a token database, (c) retrieving each corresponding replacement token from the token database, and (d) generating the translated source object by compiling all of the retrieved replacement tokens in the second language and any parsed source token in the first language for which there was no corresponding replacement token.

In one embodiment, the token database is created by performing the steps of: (i) receiving the source object from the server, (ii) parsing the source object into the plurality of source tokens, (iii) assigning a unique key to each of the plurality of source tokens, and to its corresponding replacement token, (iv) receiving a plurality of replacement tokens from a translator, the replacement tokens being a part of a set of replacement tokens, and (v) associating each source token with a corresponding replacement token. In one embodiment, the step of assigning a unique key to each source token includes applying a mathematical product to the source token. The mathematical product includes a hash function.

In one embodiment, the finding replacement token step further comprises the steps of: (i) parsing the source object for the source token, (ii) employing the function to assign the source token key, and (iii) using the key as an index into the replacement tokens to retrieve a replacement token corresponding to the source token from the token database. In one embodiment, the first language and the second language are different natural languages. In another embodiment, the first language and the second language are the same natural language with different locale characteristics. In yet another embodiment, the first language and the second language are the same natural language with different client specific characteristics.

In one embodiment, the source object received by the proxy contains images, and the translated source object contains different images. At least one of the source objects is an image file and its corresponding replacement object is a different image file. The source object received by the proxy contains a natural language expressed in a binary encoding standard. In one embodiment, the source object is translated by the proxy to a different binary encoding standard. In another embodiment, the source object is translated by the proxy to the same binary encoding standard. In yet another embodiment, the source object is translated by the proxy to the same binary encoding standard with additional client specific information.

In one embodiment, the client comprises a computer having a web browser and wherein the client request comprises a hypertext protocol (HTTP) request. The method further includes the step of: (i) determining a client's characteristics from the client request, (ii) storing the client's characteristics in a cookie storage at the proxy, and (iii) selecting the appropriate set of the replacement tokens for use by the proxy in the generating the translates source object step based upon the client's characteristics as indicated by the cookie. The client's characteristics identify at least one of the client's natural language preference, the client's natural language and locale preference, and the client company terminology preference.

In another aspect, the present invention relates to a method for creating a translated source object. In one embodiment, the method includes the steps of: (i) retrieving the source object, the source object being in a first language, (ii) parsing the source object into a plurality of source tokens, each source token representing portions of the source object in the first language, (iii) storing the source tokens in a token database, (iv) presenting each of the source tokens to a translator in a user interface, (v) for one or more of the source tokens, receiving a corresponding replacement token in a second language from the translator accessing the user interface, (vi) associating each replacement token in the second language received from the translator with its corresponding source token in the token database; and, thereafter, (vii) making the translated source object available upon request, wherein the translated source object includes all of the replacement tokens in the second language and any source tokens for which there are no corresponding replacement tokens in the second language.

The source object is retrieved from a server and the source object is a web page, a http link, a video or audio link. The portions of the source object represent natural language segments of a phrase, sentence, or paragraph in the first language. In one embodiment, the user interfaces is textual. In another embodiment, the user interface is graphicle. In one embodiment, the method further includes the steps of: (i) for one or more of the source tokens, receiving a corresponding replacement token in a third language from a second translator accessing the user interface, (ii) associating each replacement token in the third language received from the second translator with its corresponding source token in the token database, and, thereafter (iii) making the translated source object available upon request. The request identifies the requested language for the source object. The requested language is either the second or the third language. The translated source object includes all of the replacement tokens in the requested language and any source tokens for which there are no corresponding replacement tokens in the requested language.

In one embodiment, the first language and the second language are different natural languages. In another embodiment, the first language and the second language are the same natural language with different locale characteristics. In yet another embodiment, the first language and the second language are the same natural language with different client specific characteristics.

In one embodiment, the source object received by the proxy contains images, and the translated source object contains different images. At least one of the source objects is an image field and its corresponding replacement object is a different image field. The source object received by the proxy contains a natural language expressed in a binary encoding standard. In one embodiment, the source object is translated by the proxy to a different binary encoding standard. In another embodiment, the source object is translated by the proxy to the same binary encoding standard. In yet another embodiment, the source object is translated by the proxy to the same binary encoding standard with additional client specific information.

In yet another aspect, the present invention relates to a proxy for providing a translated source object. In one embodiment, the proxy has (i) an input filter adapted for receiving a request for a source object in a second language and wherein the source object is stored on a server in a first language, (ii) and output interface adapted for retrieving the requested source object from the server, (iii) a cookie storage, (iv) a token database that stores a plurality of source tokens received from the server in the first language, ad their corresponding replacement tokens received from one or more translators in the second language, (v) a translating engine, and (vi) an output filter for transmitting the translates source object to the client. The translating engine is for generating the translated source object and it performs the steps of: (a) parsing the source object into a plurality of source tokens in the first language, (b) for each source token in the first language, determining if there is a corresponding replacement token in the second language in a token database, (c) retrieving each corresponding replacement token from the token database, (d) generating the translated source object by compiling all of the retrieved replacement token in the second language and any parsed source token in the first language for which there was no corresponding replacement token.

The proxy further includes an editing tool. The editing tool has a first input for receiving the client request for source objects from the server, an output for presenting source tokens to a translator, and a second input for receiving corresponding replacement tokens from the translator. The editing tool performs the steps of: (a) presenting each of the source tokens to a translator in a user interface, (b) for one or more of the source tokens, receiving a corresponding replacement token in a second language from the translator accessing the user interface, (c) associating each replacement token in the second language received from the translator with its corresponding source token in the token database, and, thereafter, (d) making the translated source object available upon request, wherein the translates source object includes all of the replacement tokens in the second language and any source tokens for which there are no corresponding replacement tokens in the second language.

In one embodiment, the first language and the second language are different natural languages. In another embodiment, the first language and the second language are the same natural language and the second language are the same natural language with different client specific characteristics.

In one embodiment, the source object received by the proxy contains images, and the translated source object contains different images. At least one of the source objects is am image field and its corresponding replacement object is a different image file. The source object received by the proxy contains a natural language expressed in a binary encoding standard. In one embodiment, the source object is translated by the proxy to a different binary encoding standard. In another embodiment, the source object is translated by the proxy to the same binary encoding standard. In yet another embodiment, the source object is translated by the proxy to the same binary encoding standard with additional client specific information.

In one embodiment, the client is a computer. The computer further has a web browser. The client request is a hypertext transport protocol (HTTP) request. The input filter of the proxy further performs the steps of: (a) determining a client's characteristics from the client request, (b) storing the client's characteristics in a cookie storage at the proxy. The cookie is used by the translating engine for selecting the appropriate set of replacement tokens for use by the proxy in the generating the translated source object step based upon the client's characteristic as indicated by the cookie. The client's characteristics identify at least one of the client's natural language preference, the client's natural language and locale preference, and the client company terminology preference.

In a further aspect, the present invention relates to a computer-readable medium. In one embodiment, the computer-readable medium has computer-executable instructions for performing the steps of: (a) receiving a request from a client for a source object in a second language, the source object stored on a server in a first language, (b) retrieving the requested source object from the server, (c) creating the translated source object in the second language, and (d) transmitting the translated source object to the client. The translated source object in the second language is created by performing the steps of: (i) parsing the source object into a plurality of source tokens in the first language, (ii) for each source token in the first language, determining if there is a corresponding replacement token in the second language in a token database, (iii) retrieving each corresponding replacement token from the token database, (iv) generating the translated source object by compiling all of the retrieved replacement tokens in the second language and any parsed source tokens in the first language for which there was no corresponding replacement token.

In one embodiment, the computer-readable medium has further computer-executable instructions for performing the steps of: (i) retrieving the source object in the first language, (ii) parsing the source object into the plurality of source tokens, each source token representing portions of the source object in the first language, (iii) storing the source tokens in the token database, (iv) presenting each of the source tokens to a translator in a user interface, (v) for one or more of the source tokens, receiving a corresponding replacement token in a second language from the translator accessing the user interface, (iv) associating each replacement token in the second language received from the translator with it corresponding source token in the token database, and, thereafter, (vii) making the translated source object available upon request. The translated source object includes all of the replacement tokens in the second language and any source tokens for which there are no corresponding replacement tokens in the second language.

In one embodiment, the first language and the second language are different natural languages. In another embodiment, the first language and the second language are the same natural language with different locale characteristics. In yet another embodiment, the first language and the second language are the same natural language with different client specific characteristics.

These and other aspects of the present invention will become apparent from the following description of the preferred embodiment taken in conjunction with the following drawings, although variations and modifications therein may be affected without departing from the spirit and scope of the novel concepts of the disclosure.

### BRIEF DESCRIPTION OF THE DRAWINGS

The accompanying drawings illustrate one or more embodiments of the invention and, together with the written description, serve to explain the principles of the invention. Wherever possible, the same reference numbers are used throughout the drawings to refer to the same or like elements of an embodiment, and wherein:

FIG. 1 is an overall system view of a translating proxy for providing a translated source object according to one embodiment of the present invention.

FIG. 2 is a detailed block diagram of an exemplary translating proxy for providing a translated source object according to one embodiment of the present invention.

FIG. 3 is a program flowchart for translating engine for use in connection with a translating proxy according to one embodiment of the present invention.

FIG. 4(A) is a screen view of a portion of a list of available languages for selection by a translator to provide translated replacement tokens according to one embodiment of the present invention.

FIG. 4(B) is a screen view of a portion of a list of original source tokens in their original language and a list of translated replacement tokens in another language provided by a translator according to one embodiment of the present invention. Both source tokens and the replacement tokens are stored in a token database.

FIG. 5(A) shows a graphic user interface for a translator to provide replacement tokens based on the original source tokens according to one embodiment of the present invention.

FIG. 5(B) shows an exemplary source token set and its replacement token set after the translator finished providing the translation. Identical pairs of source tokens and replacement tokens are removed to save space in a token database.

FIG. 6(A) shows the HTML source text of an exemplary web page in English according to one embodiment of the present invention.

FIG. 6(B) shoes the HTML source text of a translated version of the web page shown in FIG. 6A according to one embodiment of the present invention.

FIG. 7(A) shows the exemplary web page with the source text shown in FIG. 6A according to one embodiment of the present invention.

FIG. 7(B) shows the translated version of the web page shown in FIG. 7A according to one embodiment of the present invention.

### DETAILED DESCRIPTION OF THE INVENTION

Prior to a detailed description of the invention(s), the following definitions are provided as an aid to understanding the subject matter and terminology of aspects of the present invention(s), are exemplary, and not necessarily limiting of the invention(s), which are expressed in the claims. Whether or not a term is capitalized is not considered definitive or limiting of the meaning of a term. As used in this document, a capitalized term shall have the same meaning as an uncapitalized term, unless the context of the usage specifically indicates that a more restrictive meaning for the capitalized term is intended. A capitalized term within the glossary usually indicates that the capitalized term has a separate definition within the glossary. However, the capitalization or lack thereof within the remainder of this document is not intended to be necessarily limiting unless the context clearly indicates that such limitation is intended.

Domain: a hostname that provide more easily memorable name to stand in for numeric IP addresses. They allow for any service to move to a different location to the topology of the Internet (or another internet), which would then have a different IP address. A Domain Name System (DNS) hierarchy consists of the root-level domain at the top, underneath which are at the top-level domains, followed by second-level domains and finally subdomains.

Dynamic Web Page: (1) it contains dynamic content (e.g., images, text, form fields, etc.) that can change/move without the Web page being reloaded or (2) Web pages that are produced on-the-fly by server-side programs, frequently based on parameters in the URL or from an HTML form.

Hash Function: (or hash algorithm) is a way of creating a small digital “signature” from any kind of data. The function chops and mixes the data to create the signature, often called a hash value. The hash value is commonly represented as a short string of random-looking letters and numbers mixture. Sometimes it is represented as binary data written in hexadecimal notation.

HTML: is a markup language designed for the creation of web pages with hypertext and other information to be displayed in a web browser.

Hyperlink: or a link, is a reference in a hypertext document to another document or other resource, as such it is similar to a citation in literature. Combined with a data network and a suitable access protocol, a computer can be instructed to retrieve the referenced resource.

Internet: is the worldwide, publicity accessible system of interconnected computer networks that transmit data by switching using the standard Internet Protocol (IP). It consists of million of smaller domestic, academic, business, and government networks, which together carry various information and services, such as electronic mail, online chat, fine transfer, and the interlinked Web pages and other documents of the World Wide Web.

Language Family: is a group of languages having similar language characteristics such as British English, American English, or Australia English, which are all subsets of the top-level language of English. A client's request for a particular language preference may be substituted by one of the languages in it language family, if a replacement token in requested language is not otherwise available.

Locale: is a set of parameters that further defines the user's language, country and any special variant preferences that the user wants to see in their user interface in more granular detail. Usually a locale identifier comprises a specific region, a specific corporation, or a specific variant preference.

Source Object: any electronic documents exist on computers or on the internet, such as a plurality of web pages, http links, audio or video links.

Static Web Page: it contains static content (e.g., images, text, form, fields, etc.) that will remain relatively unchanged for an extended period of time.

Token: any portion of an electronic document, such as a word, a phrase, a multi-phrase segment of a sentence, a sentence, a multi-sentence paragraph, one or more paragraphs, or an entire article. Source tokes are tokens extracted from a source object. Replacement tokens are tokens provided by one or more translators for use in the place of their corresponding source tokens.

Uniform Resource Identifier (URI): is a short string of characters used to identify or name a resource.

Uniform Resource Locator (URL): is a string of characters conforming to a standardized format, which refers to a resource on the Internet by its location.

Website: is a collection of Web pages, typically common to a particular domain name or subdomain on the World Wide Web on the Internet.

World Wide Web: is a global, read-write information space. Text documents, images, multimedia and many other items of information, referred to as resources, are identified by short, unique, global identifiers called Uniform Resource Identifiers (URIs) so that each can be found, accessed and cross-referenced in the simplest possible way.

Web Page: is a resource of information on the World Wide Web, viewed through a web browser. This information, usually in HTML/XHTML format, may enable navigation to other web pages, with hypertext links.

WYSIWYG: short for “what you see is what you get”.

XHTML: Extensible HyperText Markup Language, is a markup language that has the same expressive possibilities as HTML, but a stricter syntax.

### DESCRIPTION OF PREFERRED EMBODIMENTS

The present invention is more particularly described in the following examples that are intended as illustrative only since numerous modifications and variations therein will be apparent to those skilled in the art. Various embodiments of the invention are now described in detail. Referring to the drawings, like numbers indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dicatates otherwise.

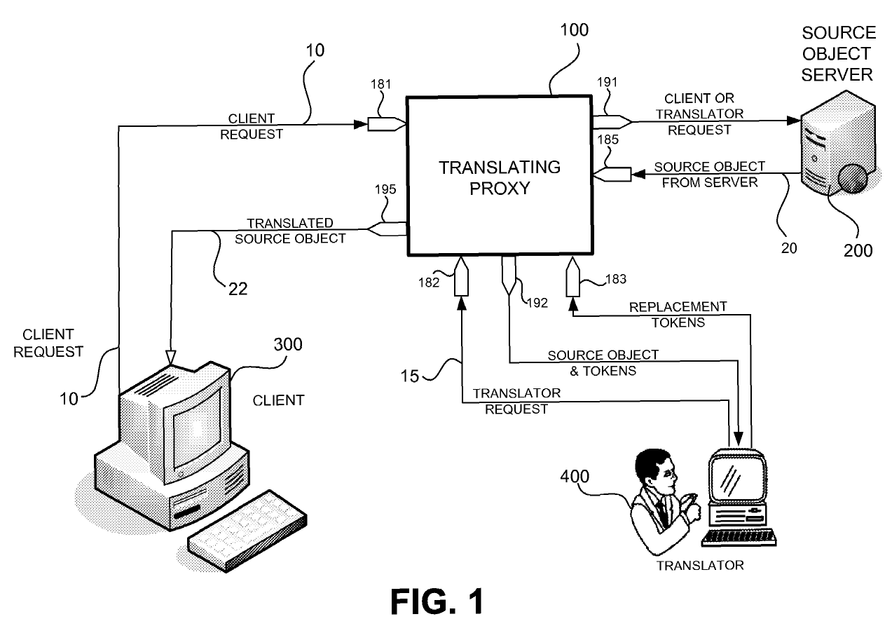

The description will be made as to the embodiments of the present invention in conjunction with the accompanying drawings in FIGS. 1-7. In accordance with the purpose of this invention, as embodied and broadly described herein, this invention, in one aspect, relates to a proxy for real time translation of source objects between a server and a client.

Normally, a client sends a client request to retrieve source objects (e.g. web pages or other electronic documents) hosted at the source object server (such as a web server). The request is sent through the network and the source object server receives the request. The web server sends the requested source object back to the client, and the client displays the retrieved source object on the computer screen. This is a WYSIWYG situation without translation. The client sees the display of the source object in its original language. In order to offer a translation service, a proxy, such as the proxy described in the present invention, is preferably used.

As shown in FIG. 1, a translating proxy 100 is placed in between a conventional client 300 and a conventional source object server 200. The client 300 is a computer with a web browser, such as Internet Explorer, Firefox, Mozilla, or the like. The source object server 200 is typically a web server or electronic document server. The client is connected to a computer network, such as a local area network (LAN), a wide area network (WAN), or the Internet. The translating proxy 100, the client 300 and the source object server 200 are either connected in a LAN configuration or over the Internet, or some combination of the above, as is known by those skilled in the art. As will be described hereinafter, one or more translators 400 also interact with the translating proxy 100.

The translating proxy 100, as shown generally in FIG. 1, includes a plurality of inputs 181, 182, 183, and 185 and a plurality of outputs 191, 192, and 195. Input 181 receives a client request 10, which is typically a request for a web page or other electronic document maintained on source object server 200. Conventionally, the client request 10 will also include cookies and other information, such as language preference and physical location, about the client 300 or the user of the client 300—such information being generally referred to hereinafter as “client characteristics.”

Input 182 is adapted to receive a translator request 15 for a web page or other electronic document maintained on source object server 200 for translation purposes. Output 191 passes the client request 10 or translator request 15 on to the source object server 200. Input 185 receives responses from the source object server 200—for a requested web page, such responses are typically in the form of HTML source. Output 192 transmits source objects and source tokens to the translator 400. Input 183 receives replacement tokens associated with the source object back from the translator 400. Output 195 transmits the translated (if necessary) source object 22 to the client 300.

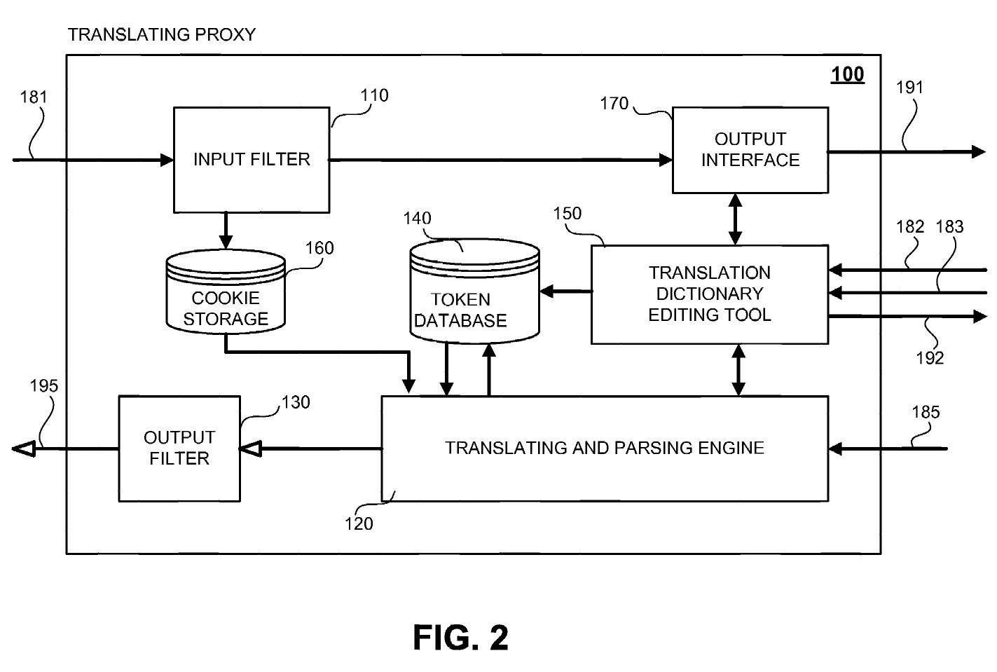

The components of the translating proxy 100, as shown in detail in FIG. 2, include an input filter 10 that receives communication from input 181, an output interface 170 that communicates through output 191 with the source object server 200, a translation directory editing tool 150 that communicates through I/Os 182, 183, and 192 with a translator 400, a translating and parsing engine 120 that receives communication from input 185, a token database 140, a cookie storage 160, and an output filter 130 that communicates through output 195 with the client 300. The function and purposes of each of these components will be discussed in greater detail hereinafter.

### Creating a Translated Source Object

Before a translated source object 22 can be provided to a client 300, such translated source object 22 must be created by the translating proxy 100. Such translated source object 22 can only be created after an existing source object is parsed and suitable replacement tokens associated with the source object have been created by a translator 400.

Advantageously, one or more translators 400 are able easily and quickly to generate translated source objects 22, such as a web page or other electronic document, based on an original source object 20 maintained on the source object server 200. This is done by parsing, separating, or otherwise dividing the source object into a plurality of source tokens and then enabling the translator 400 to create replacement tokens in a desired language, dialect, locale tongue, or company-specific arrangement—all of which can be done by a translator who does not need to have the technical training to create an original or translated web page in a web page format.

Specifically, as shown in FIGS. 1 and 2, a translator 400 starts the process of creating a translated source object 22 by first requesting the original source object 20 from the source object 200. Thus is done by sending a translator request 15 to the translating dictionary editing tool 150 and forwarded through the output interface 170 to the source object server 200. The source object server 200 sends the original source object 20 back to the translating proxy 100 through input 185. The source object 20 is received by the translating and parsing engine 120, which then parses the source object 20 into a plurality of source tokens.

Preferably, the source object 20 is or contains a web page, electronic document, a http link(s), a video, graphic, or audio link or file, or combinations of one or more of the above. When the source object is a web page or an electronic document, it can be divided or parsed into discrete sections or segment. Preferably, each section or portion of text represents a natural language segment of a phrase, sentence, or paragraph of text. Each of these portions of the source object 20 is called a source token. The source tokens can be as small as a word or as large as one or more paragraphs. Obviously, the source tokens are in the language of the source object, which we will arbitrarily call the “original”, “primary” or “first” language.

Preferably, the source object 20 is parsed into a plurality of source tokens using a customized HTML parser. The parser is commonly described as a “stream tokenizer.” It runs a cursor through a string and finds boundaries according to rules to build the tokens. Text tokens can be either “translatable” or “not translatable.” An attempt is made to access a hash to swap out the translatable token with a replacement token. Token order is maintained and tokens are reassembled into a stream.

The parser is preferably designed to find text between HTML tags. It is augmented with the ability to identify data in text between tags. Also it inspects particular tags for possible translatable text in variable values, (for example, the “src” or “alt” of the <IMG> tag, or the “value” of a <INPUT TYPE=BUTTON> tag). One skilled in the art will appreciate that numerous parsing rules and systems for breaking out a source object into relevant text, file, and link portions using tags and similar variables within HTML code or other electronic documents formats can be used within the scope of the present invention,

The translation dictionary editing tool 150 then transmits the original source object 20 and the parsed source tokens associated with the original source object through input 192 to the translator 400 for viewing and inputting of replacement tokens in another, preferred language. The source object 20 and the parsed source tokens are presented to the translator in a user interface, which is either hosted by the translating proxy 100 and accessible remotely or through a standalone application running on the computer of the translator 400 that receives the relevant data from the translating proxy 100, as will be appreciated and understood by those skilled in the art.

The translator 400 identifies what language, dialect, tongue, or company-specific format the replacement tokens will be in. In one embodiment, this step of identifying the replacement token language (“second” or “secondary” language) is done after the source object and source tokens are provided to the translator. In other preferred embodiments, this step of identification is done earlier and communicated to the translating proxy with the translator request 15. This second embodiment enables the translating proxy 100 to provide one or more sets of replacement tokens to the translator for viewing and potential use, whether as part of a saved but unfinished translation of a source object or as a recommended/suggested set of replacement tokens that translator can start with (e.g., from a top level language for which the replacement tokens will be a subset). The source object is provided to the translator so that the original web page or electronic document can be viewed in its entirety using a conventional web browser.

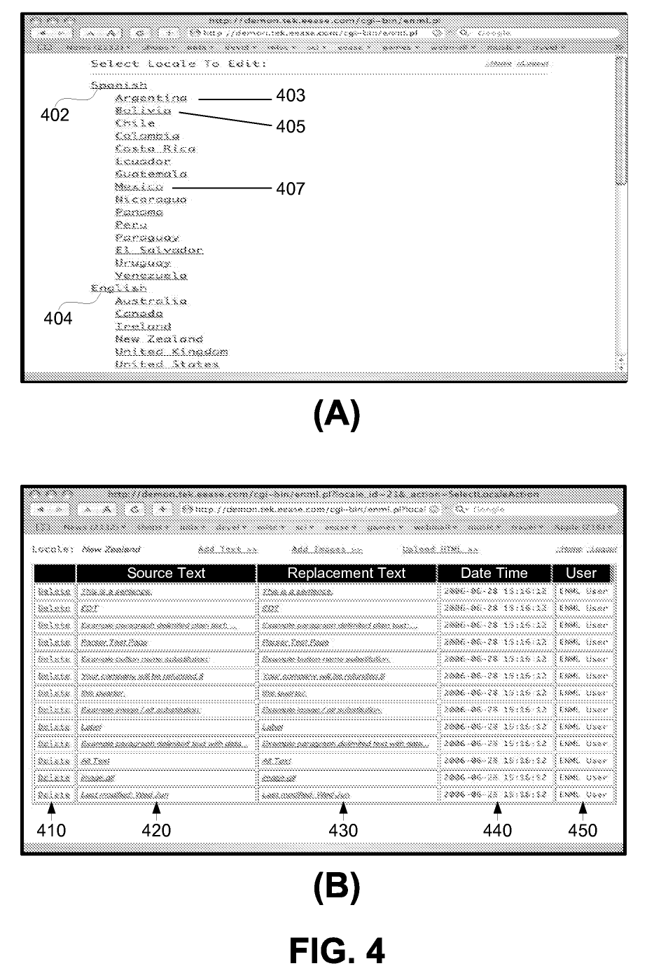

FIG. 4(A) illustrates one exemplary screen shot presented to a translator 400 and from which the translator is able to identify what language, dialect, tongue, or company-specific format the replacement tokens will be in. For example, the user is presented with a list of languages (e.g. English 404 or Spanish 402, additional languages are viewable by scrolling down the screen further) and then with specific countries or locales (e.g., Argentina 403, Bolivia 405, Mexico 407) that are listed below or as subsets to specific languages. This type of arrangement or hierarchy allows the translator to select a specific language translation that they will enter (e.g., Spanish) or be even more specific about the dialect or country-specific language be will input. As will be appreciated by those skilled in the art, when a Spanish replacement token set is created, such set will, by default, be applicable to all of the countries, locales, and dialects that fall under or part of the Spanish-speaking locations. However, when a specific county or locale is chosen and a specific replacement set is created for that country or locale, such more specific replacement token set will supersede the more general language replacement token set.

Once a secondary language, dialect, country, or locale has been selected and once the translator has received the source object and associated list of source tokens from the translating proxy 100, the translator 400 is presented with a user interface, such as the exemplary once illustrated in FIG, 4(B). In this example, the source tokens and corresponding replacement tokens are presented in tabular format. Source tokens are listed in column 420 and corresponding replacement tokens are listed in column 430. Column 410 includes a “delete” button for each source token-replacement token combination. The date and time of last modification or update of the replacement token is shown in column 440 and the name or other identification of the translator who made the last update is shown in column 450.

Typically, when a list of source tokens is first presented to a translator 400 in column 420, the replacement tokens presented in column 430 will, by default, be identical to the source tokens. If the translator has already made an initial but incomplete pass through the list of source tokens, the translating proxy 100 will provide the translator with the previously-saved version of replacement tokens in addition to the source object and source tokens. If the translator is inputting a dialect, country, or company specific replacement text that is subset of language for which replacement tokens already exist, such language replacement tokens will be presented by default. The purpose of the delete buttons shown in column 410 is to enable the translator to delete any source token (text, file, hyperlink, number, or the like) that does not need to be translated. The effect of such deletion will be that the original source token will appear or be used in any translated page for that particular replacement token set. Thus, any source token that is text will appear in its source language. If the source token is a file, such as an image or other multimedia field, the replacement token can indicate an alternative file that should be accessed when provided a translated source object or, if the source token is deleted, then the original source token will continue to be used when a translated source object is created.

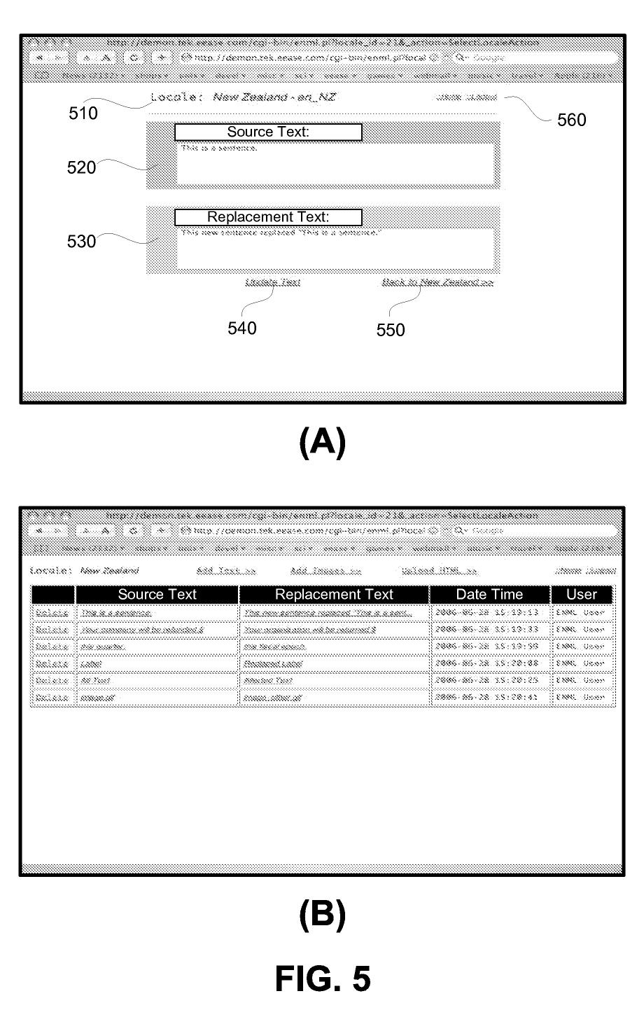

The translator has two ways of inputting replacement token for a particular source token. The text or file name of hyperlink can be types directed into the appropriate field of column 430 of FIG. 4(B) or, if any line of the table from FIG. 4(B) is selected (e.g., by double clicking, or the like), the translator is presented with a replacement token entry or editing screen, similar to the one shown in FIG. 5(A).

FIG. 5(A) indicates at 510 in which language, dialect, locale, country, or company the translator is providing replacement tokens. Current source text is displayed in field 520 and an editing field 530 enables the translator to type in replacement tokens therein. A button 540 allows the translator to save the translated replacement token and get the next source token for translation. If the translator wishes to return to the table of source tokens and replacement tokens shown in FIG. 4(B), he can click the link 550 to do so. By way of example, FIG. 5(A) indicates at 510 that the replacement tokens being saved are part of the New Zealand locale, which is a subset of the English language family. Thus, although the replacement token is in English, it is intended to be standard English with New Zealand characteristics (as applicable). For this reason, if the source tokens and replacement tokens are in the same language, the replacement token set tend not to be very large since many of the source token terms will be the same for standard English as for New Zealand English. As will be explained, the token database is not required to store any token that is identical in both source token set and replacement token sets.

FIG. 5(B) illustrates the table of FIG. 4(B) after numerous source tokens have been deleted and after replacement tokens have been input for a number of source tokens. The replacement tokens generated and input by the translator 400 for the selected language, dialect, tongue, or company are then transmitted to the translating proxy 100. The source tokens and corresponding replacement tokens are then stored in token database 140. All of the replacement tokens are associated with an appropriate identifier that indicates the language, dialect, country, tongue, or company for which the replacement tokens apply. In a preferred embodiment, a hierarchy of languages for a check for a particular substitution may be determined by parsing the “cookie” value string. For example, “es” could indicate Spanish, while “es_GU” could be Guatemalan Spanish, and “es_CompanyA” could be Company A's preferred Spanish translation. The substitution logic would use a fall back list, in reverse order. In the latter case, the system would check the database for Company A preferred result, if empty, then check generic Spanish result.

To make retrieval easier and quicker, it is preferred that each source token and all of its corresponding replacement tokens (for each language, dialect, tongue, country or company) be assigned or associated with a unique key or number. Preferably, a mathematical formula or product is applied to a source token to generate the unique key that is assigned to that source token and to all of its corresponding replacement tokens, if there is more than one set of replacement tokens that have bee created for the source object. Preferably, the mathematical product is a hash function that is applied to the source token, which generates a unique number/key that can be reproduced for the same source token for later look up and retrieval and which ensures that the key is uniquely associated with a specific source token.

In one embodiment, the first language and the second language are different natural languages. In another embodiment, the first language and the second language are the same natural language but with different locale, country, or dialect characteristics. For example, it may be desirable or necessary to translate American English words such as “theater” and “organization” to the British English word equivalents of “theatre” and “organisation”. If the words are the same in both the source language and the target language, no translation is necessary. In yet another embodiment, the first language and the second language are the same natural language with different client specific characteristics (e.g., and “employee” for one company may be called a “shareholder” at another company and an “associate” at a third company).

As described earlier, the source object 20 received by the translation proxy may contain images, and the translated source object 22 may contain different images. When a source token is an image, the URL or file name of the source token is replaced by the URL or file name of the replacement token.

If the source object 20 received by the translation proxy contains a natural language expressed in a binary encoding standard, then in one embodiment, the source object 20 is translated by the proxy to a different binary encoding standard. In another embodiment, the source object 20 is translated by the proxy to the same binary encoding standard. In a further embodiment, the source object 20 is translated by the proxy to the same binary encoding standard with additional client specific information.

### Providing the Translated Source Object

Once a set of replacement tokens has been created for a particular source object 20 having an original language wherein the replacement tokens are in a second language, dialect, country, tongue, or company, it is possible for the translating proxy 100 to provide a translates source object 22 in that second language upon request. Referring now back to FIG. 1 and FIG. 2, first, the client 300 sends a client request 10 through the first input 181 to the input filter 100. The input filter 110 first determines the client's characteristics from the client request 10. The client's characteristics are then stored as a cookie in the cookie storage 160 of the translating proxy. Preferably, the client's characteristics identify the client's natural language preference, the client's natural language and locale preference, or the client's company terminology preference. These preferences are used for selecting the appropriate replacement tokens for use by the translating proxy 100 in the generation of the translated source object 22.

The input filter 110 forwards the source object request 10 to the source object server 200 through the output interface 170 and the output 191. The translating and parsing engine 120 receives the requested source object 20 in the first language from the source object server 200 through input 185. The translating engine 120 first parses the received source object 20 into a plurality of source tokens in the same way it did for presentation to the translator 400. Then the cookie in the cookie storage 160 is used by the translating and parsing engine 120 for selecting the appropriate replacement tokens for use in generating the translated source object 22 based upon the client's characteristics. For each source token in the first language, the translating engine 120 searches the token database 140 to determine if there is a corresponding replacement token in the second language in the token database 140. The translating and parsing engine 120 retrieves each corresponding replacement token from the token database 140. The translating engine 120 then generates that translated source object 22 by compiling all of the retrieved replacement tokens in the second language and any parsed source tokens in the first language for which there was no corresponding replacement token.. Finally, the translated source object 22 is transmitted to the client 300 through the output filter 130 and output 195.

As stated previously, the translating and parsing engine 120 parses the source object 20 for source tokens. For each source token, the translating engine 120 employs the mathematic produce to obtain a replacement token “look-up” key. The same mathematical product that was used to index source tokens and replacement tokens created by the translator 400 are used here for quick and accurate cross-reference purposes. The key is used as an index into the source tokens and replacement tokens stored in the token database 140 to retrieve the appropriate replacement token corresponding to the parsed source token and corresponding with the preferred language, dialect, country or company specific language obtained from the cookie.

For each language into which the translating proxy 100 is adapted to provide a translated source object, the token database 140 must have a set of corresponding replacement tokens. As stated previously, such replacement tokens may be merely at the top level languages of English, Spanish, French, German, Chinese, Japanese, etc., or they can be more accurately subdivided into specific country, locale, or dialect variations under one of the top level languages. For example, major Spanish speaking countries include Argentina, Bolivia, Chile, Columbia, Costa Rica, Ecuador, Guatemala, Mexico, Nicaragua, Panama, Peru, Paraguay, El Salvadore Uruguay and Venezuela. Each of these individual countries can have its own set of replacement tokens or, if none has (yet) been created, any client requesting a specific locale would be given the default top-level language under which it is included. The bigger the difference between a locale language and its standard language, the larger the replacement token set for the locale language.

The natural languages used by the source tokens and the plurality of replacement token sets are generally going to be expressed in binary encoding standards. In one embodiment, the natural languages used by the source tokens and the replacement tokens are expressed in one binary encoding standard. In another embodiment, the natural languages used by the source tokens and the replacement tokens are expressed in different encoding standards. The number of words or symbols used in a replacement token may be the same or different that the number of words or symbols that appear in the corresponding source token.

As previously explained, the client characteristics obtained from the client request can be used to select the requested or preferred language of the translated source object. Assuming the source object 20 is in English, for example, if the client uses English, no translation is necessary. If the client uses Spanish, and in particular, Ecuadorian Spanish, the translation is done from English to Ecuadorian Spanish. If an Ecuadorian Spanish, the translation is done from English to Ecuadorian Spanish. If an Ecuadorian Spanish replacement token set is not available, then the closest similar locale (e.g., Bolivia) or the top-level language (e.g., standard Spanish) replacement token set is used to create the translates source object. Therefore, the first, original, or primary language is determined by the retrieved source object 20 and the second language is determined by the client's preferences. The client's preferences include the natural language preference, as well as the locale preferences. In the example above, there are many idiosyncrasies in different regions where Spanish is the dominant language. People in Ecuador speak slightly differently from the people in Mexico. In order to provide accurate translation, these differences are taken into account.

In addition to the language preference, the client characteristics can indicate what company the client is affiliated with. Such information could be used to advantage in situations in which a standard web page or electronic document needed to be provided to multiple companies in a customized or branded manner. For example, a standard letter from a President of one company could be addressed alternatively to “Customers”, “Partners”, “Shareholders”, or “Employees” depending upon the client characteristics obtained from the client's request. In another example, a generic health policy could be customized for viewing by employees from multiple companies—with employees from each company viewing the policy with their specific terminology used and with their company's logo or brand displayed in a banner or in the header. The uses of such replacement tokens are nearly limitless.

During the creation of replacement tokens and for later creation of a translated source object, HTML format information for web page may be skipped and preserved. Only the portions corresponding to the source tokens are presented to the translator for translation and, correspondingly, only the source tokens having corresponding replacement tokens are substituted in the HTML code. Thus, when the source object is a web page, the translated source object merely comprises the retrieved source object 20 with substituted replacement tokens inserted therein. Such translated source object 22 is forwarded to the output filter 130, which prepares and sends the final HTML source to the client through the computer network to be displayed by the client.

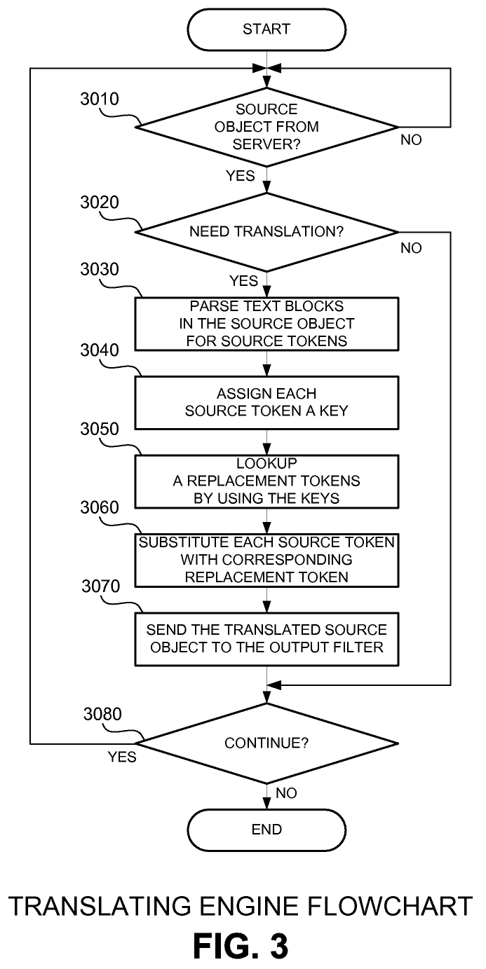

FIG. 3 illustrates the specific steps that are performed by the translating proxy 100 according to one embodiment of the present invention. At the beginning, the translating engine first checks to see if there is any input from source object server at step 3010. If there is not any input, the translating engine goes back to step 3010 and waits for input from the source object server. When the input (HTML source) from the source object server is received, the translating engine checks with the translation flag to determine whether a translation is needed at step 3020. If the client preference indicates that a natural language that is different from the source object is used by the client and the token database contains both the source tokens in the source language and the replacement tokens in the target language, then a translated source object can be created. The translating engine proceeds to step 3030. If the client preference specifies the same source language as the original source object uses, or, the token database does not contain both the source tokens in the source language and the replacement tokens in the target language, the translation is not needed. The translating engine proceeds to step 3080.

At step 3030, the translating engine parses the source object, extracts the displayable tokens and preserves the HTML format information. For each displayable token, the same hash function used to create the source tokens is used to generate a hash value. This hash value is assigned to the source token as a key, as shown in step 3040. At step 3050, the translating engine then looks up a replacement token from the token database by using the key generated in step 3040. If the translating engine finds a replacement token for the source token, the original source token is replaced with this replacement token, as shown in step 3060. If the translating engine does not find a replacement token, no substitution is needed—the source token will continue to be used. The translating engine continues to process the source object (HTML source) until the end of the HTML source is reached.

At the end of the HTML source, a translated version of the HTML source is generated by preserving all HTML formal information and replacing only the source tokens that had corresponding replacement tokens. This translated version of the HTML source is forwarded to the output filter 130 and sent on to the client for display.

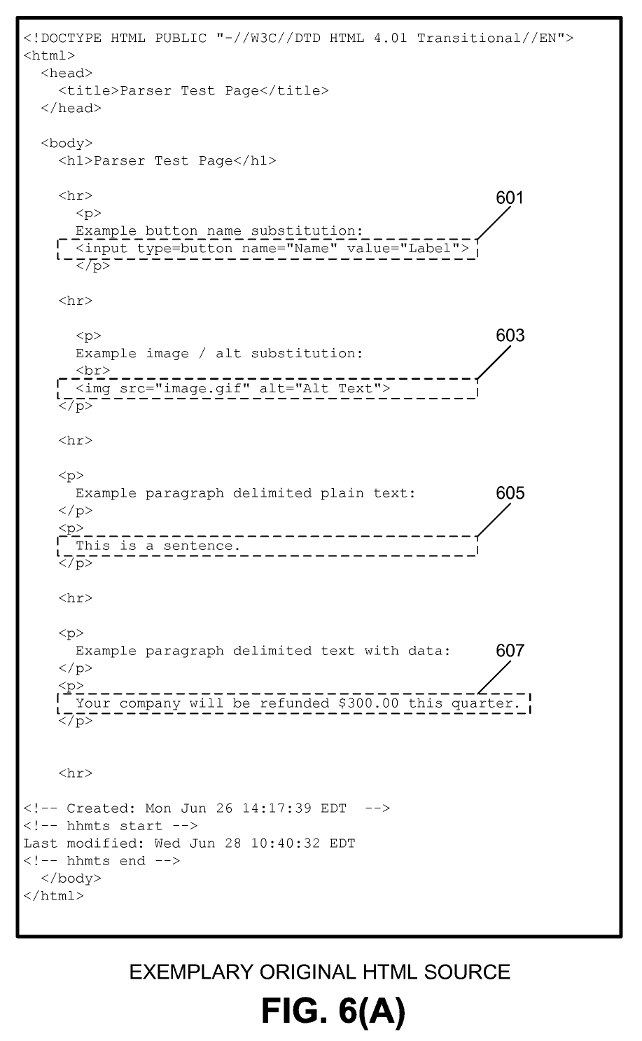

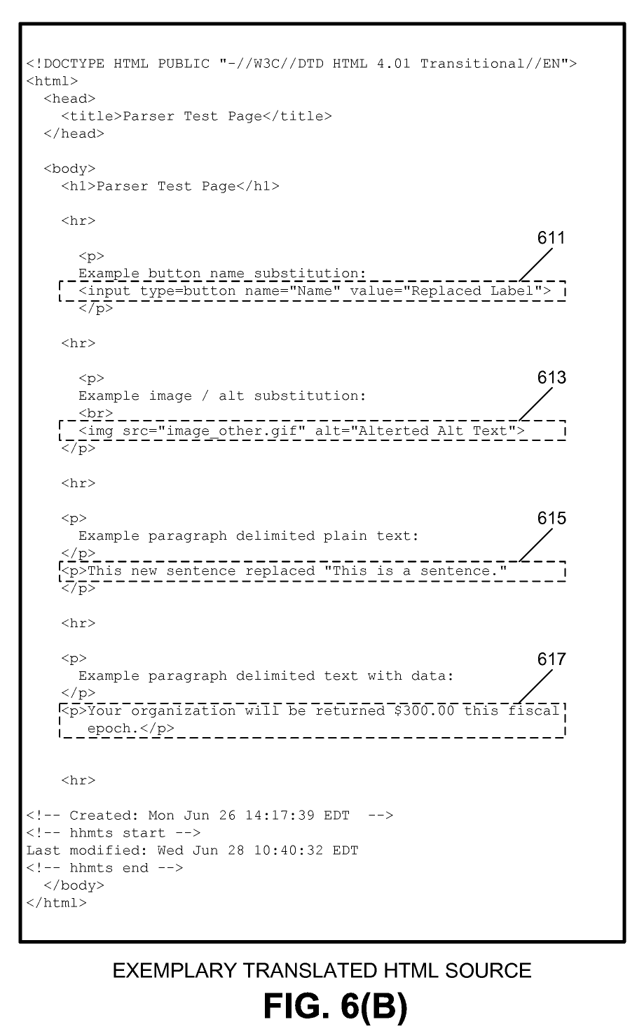

FIG. 6(A) shown the HTML source of an exemplary original web page according to one embodiment of the present invention. FIG. 6(B) shows the HTML source of the web page that has been translated into another language according to one embodiment of the present invention. In this example, the original HTML source of the web page is in English and the translated web page is in Spanish.

In FIG. 6(A), the blocks of source text 601, 603, 605, and 607 show a button marked as “Label”, an image marked as “Alt Text”, a sentence “This is a sentence.”. and a sentence with a number in between “you company will be refunded $300.00 this quarter.”, respectively. After the original source text is received by the translating and parsing engine, the HTML source of the original web page is converted into a new HTML source as shown in FIG. 6(B). The blocks of source text 601, 603, 605, and 607 are replaced by the blocks of source text 611, 613, 615, and 617 respectively. The button [Label] becomes a button marked as [Replaced Label]. The image marked as “image.gif” is replaced with an alternative image called “image_other.gif”. The sentence “This is a sentence” is replaced by the text “This new sentence replaces ‘This is a sentence.’” And the sentence “your company will be refunded $300.00 this quarter,” becomes “Your organization will be returned $300.00 this fiscal epoch.”.

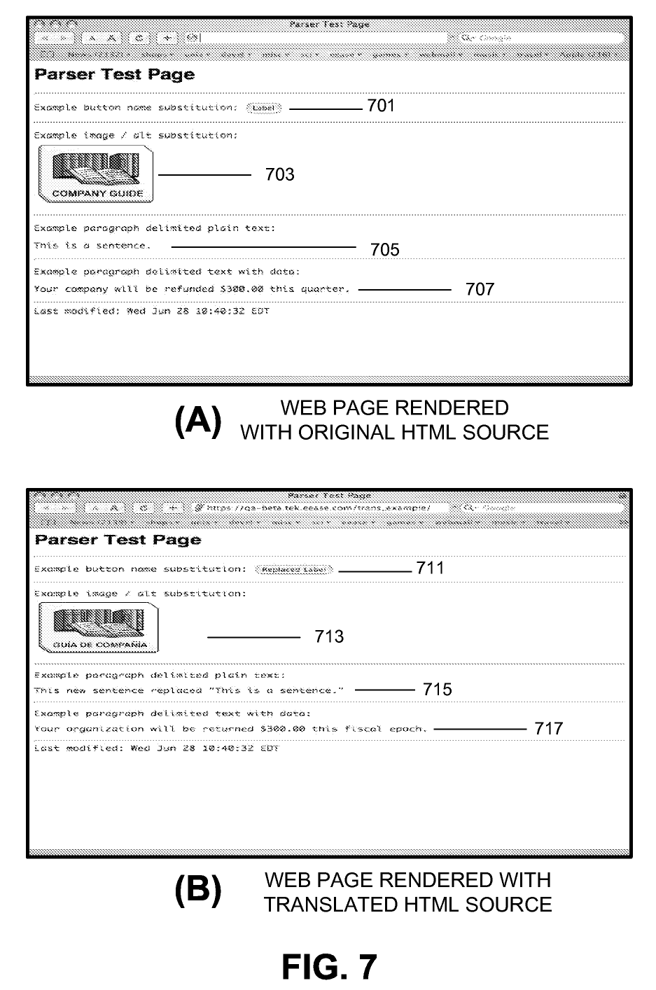

These two web pages, original source object and translated source object, are illustrated in FIGS. 7(A) and 7(B), respectively. In FIG. 7(A), the button 701 is the button represented by the source text block 601. The image 703 is represented by the source text block 603. The sentence 705 is represented by the source text block 605. The sentence 707 is represented by the source text block 607. Turning now to FIG. 7(B), the button 711 is the button represented by the source text block 611. The image 713 is represented by the source text block 613. The sentence 715 is represented by the source text block 615. The sentence 717 is represented by the source text block 617. Comparing these two exemplary web pages, one can see that the button 701 is replaced by a button 711 with different text, the image 703 is replaced by an image 713 in a different language, the sentence 705 is replaced by a longer sentence 715, and the sentence 707 is replaced by a sentence 717 with a different expression.

In addition to translating web page from one language to another, the present invention also can provide web pages tailored to specific clients. For example, if the client request brings a client specific to that company, such as displaying a company's logo, providing company specific information, company specific questions and answers, etc.

In one embodiment, the system is implemented as software. The software is stored and transported with a computer-readable medium such as a floppy disc, a memory card, a CD. The software can also be stored at an FTP site for user to download and install.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A method for providing a translated source object by a proxy, where the proxy performs the steps of:
(a) receiving a request from a client for a source object in a second language, the source object stored on a server in a first language;
(b) retrieving the requested source object from the server;
(c) creating the translated source object in the second language by performing the steps of:
i. parsing the source object into a plurality of source tokens in the first language;
ii. for each source token in the first language, determining if there is a corresponding replacement token in the second language in a token database;
iii. retrieving each corresponding replacement token from the token database; and
iv. generating the translated source object by compiling all of the retrieved replacement tokens in the second language and any parsed source tokens in the first language for which there was no corresponding replacement token; and
(d) transmitting the translated source object to the client.

2. The method according to claim 1, wherein the token database is created by performing the steps of:
i. receiving the source object from the server;
ii. parsing the source object into the plurality of source tokens;
iii. assigning a unique key to each of the plurality of source tokens, and to its corresponding replacement token;
iv. receiving a plurality of replacement tokens from a translator, the replacement token being a part of a set of replacement token; and
v. associating each source token with a corresponding replacement token.

3. The method according to claim 2, wherein the step of assigning a unique key to each source token comprises applying a mathematical product to the source token.

4. The method according to claim 3, wherein the mathematical product comprises a hash function.

5. The method according to claim 4, wherein the finding replacement token step further comprises the steps of:
i. parsing the source object for the source token;
ii. employing the function to assign the source token a key; and
iii. using the key as an index into the replacement tokens to retrieve a replacement token corresponding to the source token from the token database.

6. The method according to claim 1, wherein the first language and the second language are different natural languages.

7. The method according to claim 1, wherein the first language and the second language are the same natural language with different locale characteristics.

8. The method according to claim 1, wherein the first language and the second language are the same natural language with different client specific characteristics.

9. The method according to claim 1, wherein the source object received by the proxy contains images, with the translated source object to contain different images.

10. The method according to claim 1, wherein at least one of the source objects is am image file and its corresponding replacement object is a different image file.

11. The method according to claim 1, wherein the source object received by the proxy contains a natural language expressed in a binary encoding standard, and wherein the source object is translated by the proxy to a different binary encoding standard.

12. The method according to claim 1, wherein the source object received by the proxy contains a natural language expressed in a binary encoding standard, and wherein the source object is translated by the proxy to the same binary encoding standard.

13. The method according to claim 1, wherein the source object received by the proxy contains a natural language expressed in a binary encoding standard, and wherein the source object is translated by the proxy to the same binary encoding standard with additional client specific information.

14. The method according to claim 1, wherein the clients comprises a computer having a web browser and wherein the client request comprises a hypertext transport protocol (HTTP) request.

15. The method according to claim 14, further comprising the steps of:
(a) determining a client's characteristics from the client request;
storing the client's characteristics in a cookie storage at the proxy;
(c) selecting the appropriate set of the replacement tokens for use by the proxy in the generating the translated source object step based upon the client's characteristics as indicated by the cookie.

16. The method according to claim 15, wherein the client's characteristics identify the client's natural language preference.

17. The method according to claim 15, wherein the client's characteristics identify the client's natural language and locale preference.

18. The method according to claim 15, wherein the client's characteristics identify the client company terminology preference.

19. A method for creating a translated source object, comprising the steps of:
(a) retrieving the source object, the source object being in a first language;
(b) parsing the source object into a plurality of source tokens, each source token representing portions of the source object in the first language;
(c) storing the source tokens in a token database;
(d) presenting each of the source tokens to a translator in a user interface;
(e) for one or more of the source tokens, receiving a corresponding replacement token in a second language from the translator accessing the user interface;
(f) associating each replacement token in the second language received from the translator with its corresponding source token in the token database; and, thereafter,
(g) making the translated source object available upon request, wherein the translated source object includes all of the replacement tokens in the second language and any source tokens for which there are no corresponding replacement tokens in the second language.

20. The method according to claim 19, wherein the source object is retrieved from a server.

21. The method according to claim 19, wherein the source object is a web page, a http link, a video or audio link.

22. The method according to claim 19, wherein the portions of the source object represent natural language segments of a phrase, sentence, or paragraph in the first language.

23. The method according to claim 19, wherein the user interface is textual.

24. The method according to claim 19, wherein the user interface is graphical.

25. The method according to claim 19, further comprising the steps of:
(i) for one or more of the source tokens, receiving a corresponding replacement token in a third language from a second translator accessing the user interface;
(ii) associating each replacement token in the third language received form the second translator with its corresponding source token in the token database; and, thereafter,
(iii) making the translated source object available upon request, the request identifying the requested language for the source object, the requested language being either the second or the third language, wherein the translated source object includes all of the replacement tokens in the requested language and any source tokens for which there are no corresponding replacement tokens in the requested language.

26. The method according to claim 19, wherein the first language and the second language are different natural languages.

27. The method according to claim 19, wherein the first language and the second language are the same natural language with different locale characteristics.

28. The method according to claim 19, wherein the first language and the second language are the same natural language with different client specific characteristics.

29. The method according to claim 19, wherein the source object received by the proxy contains images, with the translated source object to contain different images.

30. The method according to claim 19, wherein at least one of the source objects is an image file and its corresponding replacement object is a different image file.

31. The method according to claim 19, wherein the source object received by the proxy contains a natural language expressed in a binary encoding standard, and wherein the source object is translated by the proxy to a different binary encoding standard.

32. The method according to claim 19, wherein the source object received by the proxy contains a natural language expressed in a binary encoding standard, and wherein the source object is translated by the proxy to the same binary encoding method.

33. The method according to claim 19, wherein the source object received by the proxy contains a natural language expressed in a binary encoding standard, and wherein the source object is translated by the proxy to the same binary encoding standard with additional client specific information.

34. A proxy for providing a translates source object, comprising:
(a) an input filter adapted for receiving a request for a source object in a second language, the source object being stored on a server in a first language;
(b) an output interface adapted for retrieving the requested source object from the server;
(c) a cookie storage;
(d) a token database that stores a plurality of source tokens received from the server in the first language, and their corresponding replacement tokens received from one or more translators in the second language;
(e) a translating engine for generating the translated source object that performs the steps of:
i. parsing the source object into a plurality of source tokens in the first language;
ii. for each source token in the first language, determining if there is a corresponding replacement token in the second language in a token database;
iii. retrieving each corresponding replacement token from the token database; and
iv. generating the translated source object by compiling all of the retrieved replacement tokens in the second language and any parsed source tokens in the first language for which there was no corresponding replacement token; and
(f) an output filter for transmitting the translated source object to the client.

35. The proxy according to claim 34, further comprising an editing tool having a first input for receiving the client request for source objects from the server, an output for presenting source tokens to a translator, and a second input for receiving corresponding replacement tokens from the translator.

36. The proxy according to claim 35, wherein the editing tool performs the steps of:
(a) presenting each of the source tokens to a translator in a user interface;
(b) for one or more of the source tokens, receiving a corresponding replacement token in a second language from the translator accessing the user interface;
(c) associating each replacement token in the second language received from the translator with its corresponding source token in the token database; and, thereafter,
(d) making the translated source object available upon request, wherein the translated source object includes all of the replacement tokens in the second language and any source tokens for which there are no corresponding replacement tokens in the second language.

37. The proxy according to claim 34, wherein the first language and the second language are different natural languages.

38. The proxy according to claim 34, wherein the first language and the second language are the same natural language with different locale characteristics.

39. The proxy according to claim 34, wherein the first language and the second language are the same natural language with different client specific characteristics.

40. The proxy according to claim 34, wherein the source object received by the proxy contains images, with the translated source object to contain different images.

41. The proxy according to claim 34, wherein at least one of the source objects is an image file and its corresponding replacement object is a different image file.

42. The proxy according to claim 34, wherein the source object received by the proxy contains a natural language expressed in a binary encoding standard, and wherein the source object is translated by the proxy to a different binary encoding standard.

43. The proxy according to claim 34, wherein the source object received by the proxy contains a natural language expressed in a binary encoding standard, and wherein the source object is translated by the proxy to the same binary encoding standard.

44. The proxy according to claim 34, wherein the source object received by the proxy contains a natural language expressed in a binary encoding standard, and wherein the source object is translated by the proxy to the same binary encoding standard with additional client specific information.

45. The proxy according to claim 34, wherein the client comprises a computer having a web browser, and wherein the client requested comprises a hypertext transport protocol (HTTP) request.

46. The proxy according to claim 45, wherein the input filter performing at least the steps of:
(a) determining the client's characteristics from the client request;
(b) storing the client's characteristics in a cookie storage at the proxy, wherein the cookie is used by the translating engine for selecting the appropriate set of the replacement tokens for use by the proxy in the generating the translated source object step based upon the client's characteristics as indicated by the cookie.

47. The method according to claim 46, wherein the client's characteristics identify the client's natural language preference.

48. The method according to claim 46, wherein the client's characteristics identify the client's natural language and locale preference.

49. The method according to claim 46, wherein the client's characteristics identify the client company terminology preference.

50. A computer-readable medium having computer-executable instructions for performing step comprising:
(a) receiving a request from a client for source object in a second language, the source object stored on a server in a first language;
(b) retrieving the requested source object in the second language by performing the steps of:
i. parsing the source object into a plurality of source tokens in the first language;
ii. for each source token in the first language, determining if there is a corresponding replacement token in the second language in a token database;
iii. retrieving each corresponding replacement token from the token database; and
iv. generating the translated source object by compiling all of the retrieved replacement tokens in the second language and any parsed source tokens in the first language for which there was no corresponding replacement token; and
(d) transmitting the translated source object to the client.

51. The computer-readable medium of claim 50, having further computer-executable instructions for performing the steps of:
(a) retrieving the source object, the source object being in a first language;
(b) parsing the source object into a plurality of source tokens, each source token representing portions of the source object in the first language;
(c) storing the source tokens in a token database;
(d) presenting each of the source tokens to a translator in a user interface;
(e) for one or more of the source tokens, receiving a corresponding replacement token in a second language from the translator accessing the user interface;
(f) associating each replacement token in the second language received from the translator with its corresponding source token in the token database; and, thereafter,
(g) making the translated source object available upon request, wherein the translated source object includes all of the replacement tokens in the second language and any source tokens for which there are no corresponding replacement tokens in the second language.

52. The computer-readable medium of claim 51, wherein the first language and the second language are different languages.

53. The computer-readable medium of claim 51, wherein the first language and the second language are the same language with different locale characteristics.

54. The computer-readable medium of claim 51, wherein the first language and the second language are the same language with different specific information.
